(19) United States
(12) Patent Application Publication
(10) Pub. No.: US 2024/0426461 A1
(43) Pub. Date: Dec. 26, 2024

(54) COMPLEMENTARY MOLD FRAME FOR BLUE LIGHT LEAKAGE

(71) Applicant: DELL PRODUCTS L.P., Round Rock, TX (US)

(72) Inventors: Pin-Huang Hsu, Taipei City (TW); Shih-Kai Wang, Taipei City (TW); Wei-Chou Chen, Kaohsiung City (TW); Chih-Chien Chang, New Taipei City (TW)

(21) Appl. No.: 18/341,214

(22) Filed: Jun. 26, 2023

(51) Int. Cl. F21V 9/32

(52) U.S. Cl. CPC F21V 9/32; F21Y 2115/10

(57) ABSTRACT

A display device includes a backlight assembly that emits blue light, and a mold frame with a portion that is coated with a yellow phosphor. Some of the blue light emitted by the backlight assembly strikes the portion of the mold frame and combines with yellow light from the yellow phosphor to produce a white light.

### FIELD OF THE DISCLOSURE

The present disclosure generally relates to information handling systems, and more particularly relates to a complementary mold frame for blue light leakage.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A display device includes a backlight assembly that emits blue light, and a mold frame with a portion that is coated with a yellow phosphor. Some of the blue light emitted by the backlight assembly strikes the portion of the mold frame and combines with yellow light from the yellow phosphor to produce a white light.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a diagram illustrating a display device with a complementary mold frame for blue light leakage, according to an embodiment of the present disclosure; and

FIGS. 3-4 are cross-sectional views of the display device taken along line 3-3 as shown in FIG. 2, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

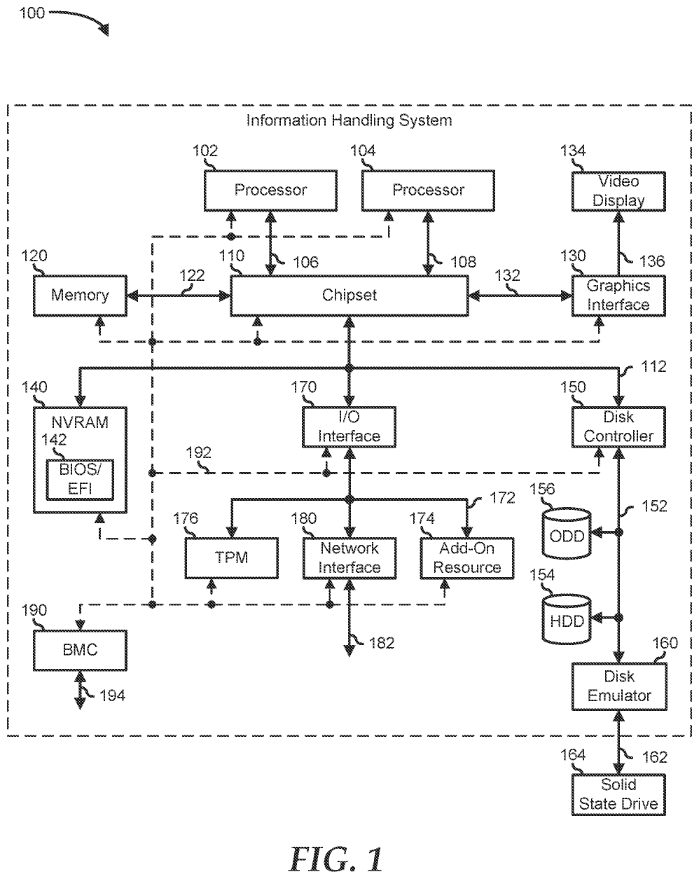

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (x4) PCIe adapter, an eight-lane (x8) PCIe adapter, a 16-lane (x16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172 and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure, information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Newer generations of display monitors include mini-light emitting diode (LED) or micro-LED backlights. To enhance the color performance of the display monitors, a quantum dot film may be used. For example, the quantum dot film is used to transform blue light emitted by the mini-LED or micro-LED backlights into white light. However in sections with missing quantum dot film, such as around the edges of the display panel, blue light leakage may occur. The present disclosure provides a system to address this and other issues.

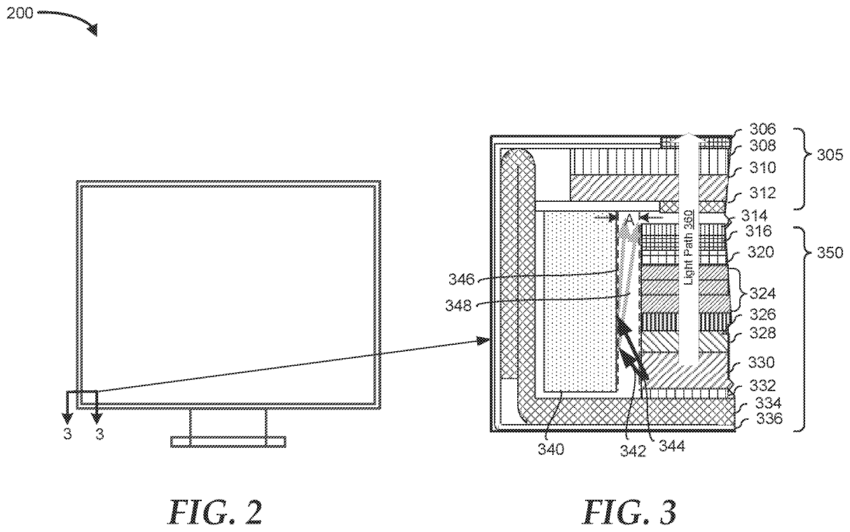

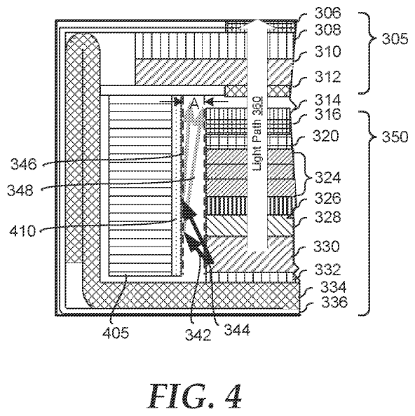

FIG. 2 shows a diagram of a display device 200 configured with a complementary mold frame of blue light leakage. Display device 200 is similar to video display 134 of FIG. 1. FIG. 3 shows a cross-sectional view of display device 200 taken along line 3-3 of FIG. 2. Referring to FIG. 2 and FIG. 3, display device 200 includes a display panel 305 configured to display an image and a backlight assembly 350 for supplying light to display panel 305, wherein backlight assembly 350 may be aligned under display panel 305. Display panel 305 includes a top polarizer 306, a color film glass 308, a thin film transistor glass 310, and a bottom polarizer 312. Backlight assembly 350 includes an up diffuser 314, a prism 316, a down diffuser 320, a diffuser sheet 324, a quantum dot sheet 326, protected glue 328, a light plate 330, a light plate tape 332, a back cover 334, a cell tape 336, and a mold frame 340. Prism 316 is disposed between up diffuser 314 and down diffuser 320. Prism 316 may be used to concentrate or direct emitted light to light path 360 while up diffuser 314 and down diffuser 320 may scatter some of the light for uniformity along with diffuser sheet 324.

Light plate 330 includes a plurality of mini-LEDs or micro-LEDs which emits blue light along light path 360. The blue lights may be between 445 and 475 nanometers (nm). As the light passes through quantum dot sheet 326, the blue light is transformed into white light. Protected glue 328 is disposed between light plate 330 and quantum dot sheet 326 to protect the mini-LEDs or micro-LEDS mounted on light plate 330. Light plate tape 332 may be used to affix light plate 330 on back cover 334. Cell tape 336 may be used for additional support of back cover 334.

Mold frame 340 may be configured to enclose a light source unit, such as backlight assembly 350, wherein an inner portion of mold frame 340 is disposed proximate to an inner portion of backlight assembly 350 with a gap, depicted by “A” in between for assembly tolerance. Accordingly, the inner portion of mold frame 340 may be proximate to light plate 330. As such, mold frame 340 may be configured to affix the positions of optical films between up diffuser 314 and quantum dot sheet 326. Further, an outer portion of mold frame 340 may be physically coupled with an inside portion of back cover 334.

Although most of the blue light emitted by the mini-LEDs or the micro-LEDs at light plate 330 follows light path 360, there may be some blue lights, such as blue lights 342 and 344, make leak out of backlight assembly 350. This blue light may leak through a gap between the inner portion of mold frame 340 and the inner portion of backlight assembly 350. The blue light leakage may be due to one or more portions of backlight assembly 350 with missing quantum dot sheet 326. Prior to this disclosure, this blue light leakage may be visible to the user around the border of the display device when the display device is in use. To address this issue, mold frame 340 may be configured as a yellow phosphor mold frame. In one embodiment, an entire outer surface area of mold frame 340 may be encapsulated or coated with yellow phosphor. In another embodiment, because yellow phosphor is stable due to its chemical structure, yellow phosphor powder may be mixed in the material for mold frame 340 during manufacture. For example, the yellow phosphor powder may be mixed with an amorphous thermoplastic polymer material, poly carbonate plastic, or similar that is used to manufacture mold frame 340. Thus, yellow phosphor can be used in various structures, such as mold frame 340. However, while the yellow phosphor used in examples herein, is an yttrium aluminum garnet phosphor, the present disclosure is applicable to other color ranges of yellow phosphors.

Yttrium aluminum garnet phosphor, also referred to herein simply as yellow phosphor, typically offers good broadband emission in the visible spectral region of 500 to 700 nm. In addition, the yellow phosphor provides an efficient absorption of blue light in the range of 420 to 480 nm like the blue light emitted by a mini-LED or a micro-LED. Mixing the blue light emitted by the mini-LED or the micro-LED with the yellow light emitted by the yellow phosphor may result in a light that is perceived as white by the human eye. In this disclosure, the transformed blue light may keep its other characteristics such as uniformity and brightness. This is in contrast with conventional solutions that block or absorb the blue light. Thus, only the white light is reflected which results in decreased brightness. However, this conventional solutions may introduce an issue with light uniformity and may also cause shadow on the edges o the display screen.

As blue lights 342 and 344 strike an inner portion of mold frame 340, they may combine with yttrium aluminum garnet light emitted by the yellow phosphor of mold frame 340. White lights 346 and 348 are produced and reflected off mold frame 340 through the gap between mold frame 340 and backlight assembly 350. Thus, instead of blue lights 342 and 344, white lights 346 and 348 may be reflected through the gap between backlight assembly 350 and mold frame 340 instead. Because white light is generally a better optical experience for a user than blue light, mold frame 340 may not include an extended section to block the reflection of the white light from leaking. This extended section is typically used currently by various display monitor manufacturers. Without the additional width of the extended section of the mold frame, mold frame 340 may be narrower than other mold frames. The narrower mold frames may result in narrower borders. The narrower mold frame is advantageous because the borders of the current display monitor are getting narrower with each succeeding generation.

FIG. 4 shows a cross-sectional view of display device 200 taken along line 3-3 of FIG. 2. The cross-sectional view of display device 200 shown in FIG. 4 is similar to the cross-sectional view of display device 200 depicted in FIG. 3. Referring to FIG. 4, backlight assembly 350 includes a mold frame 405 with a section 410 that is coated or applied with the yellow phosphor. The length and/or width of section 410 may be from a fraction of the length and/or the width of mold frame 405 to its full length. Section 410 is disposed proximate to backlight assembly 350. When blue lights 342 and 344 are emitted by light plate 330, they may strike section 410. Similar to above, as blue lights 342 and 344 strike section 410 of mold frame 340, blue lights 342 and 344 may combine with yttrium aluminum garnet light emitted by the yellow phosphor of section 410. The combination may produce and reflect white lights 346 and 348.

The components of display device 200 shown are not drawn to scale display device 200 may include additional or fewer components. Additionally, or alternatively, display device 200 may include various additional components in addition to those that are shown in FIG. 2 through FIG. 4. Furthermore, some components that are represented as separate components in FIG. 1 may in certain embodiments instead are integrated with other components. In addition, although embodiments of the present disclosure as depicted in display device 200 which is an external display device, the embodiments of the present disclosure may be applicable to a display device that is integrated into an information handling system, such as a laptop or notebook display.

Those of ordinary skill in the art will appreciate that the configuration and components of the display device depicted in FIG. 2 may vary. For example, the illustrative components within display device 200 are not intended to be exhaustive but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

1. A display device comprising:
a backlight assembly with a plurality of mini light emitting diodes (LEDs) that emit blue light; and
a mold frame having a yellow phosphor mixed in material used to manufacture the mold frame, wherein the blue light emitted by the mini-LEDs strikes the mold frame and combines with yellow light from the yellow phosphor to produce white light.

2. The display device of claim 1, wherein the yellow phosphor is a yttrium aluminum garnet phosphor.

3. The display device of claim 1, wherein an entire outer surface of the mold frame is coated with the yellow phosphor.

4. The display device of claim 1, wherein with a material comprising the mold frame encloses the backlight assembly.

5. The display device of claim 1, wherein the white light is reflected through a gap between the mold frame and the backlight assembly.

6. The display device of claim 1, wherein the blue light strikes the mold frame that is proximate to the backlight assembly.

7. A display device, comprising:
a backlight assembly that emits blue light; and
a mold frame with an outer surface area, wherein the outer surface area is coated entirely with a yellow phosphor, wherein some of the blue light emitted by the backlight assembly strikes the outer surface area of the mold frame and combines with yellow light from the yellow phosphor to produce a white light.

8. The display device of claim 7, wherein the yellow phosphor is a yttrium aluminum garnet phosphor.

9. The display device of claim 7, wherein the white light is reflected from the mold frame.

10. The display device of claim 7, wherein the mold frame encloses the backlight assembly.

11. The display device of claim 7, wherein the backlight assembly includes a plurality of mini-LEDs.

12. The display device of claim 7, wherein the outer surface area of the mold frame with the yellow phosphor is disposed proximate to the backlight assembly.

13. The display device of claim 7, wherein the white light is reflected through a gap between the mold frame and the backlight assembly.

14. The display device of claim 7, wherein the blue light that struck the mold frame was leaked from the backlight assembly.

15. A display device:
a backlight assembly with a plurality of micro light emitting diodes (LEDs) that emit blue light; and
a mold frame with yellow phosphor mixed in material used to manufacture the mold frame, wherein the mold frame is disposed proximate to the backlight assembly, and wherein the blue light emitted by the micro-LEDs strikes a portion of the mold frame and combines with yellow light from the yellow phosphor to produce white light.

16. The display device of claim 15, wherein a surface of the mold frame is coated with the yellow phosphor.

17. The display device of claim 15, wherein the yellow phosphor is a yttrium aluminum garnet phosphor.

18. The display device of claim 15, wherein the white light is reflected from the portion of the mold frame that is coated with the yellow phosphor.

19. The display device of claim 15, wherein the white light is reflected through a gap between the mold frame and the backlight assembly.

20. The display device of claim 15, wherein the yellow phosphor is mixed with a material comprising the mold frame.
